(19) United States
(12) Patent Application Publication
(10) Pub. No.: US 2023/0345963 A1
(43) Pub. Date: Nov. 2, 2023

(54) COMPOSITION, CONFECTIONERY PRODUCT AND PROCESS

(71) Applicant: Bunge Loders Croklaan B.V., Wormerveer (NL)

(72) Inventors: Imro 'T ZAND, Wormerveer (NL); Martin AALBERTS, Wormerveer (NL); Jeanine Luvelle WERLEMAN, Wormerveer (NL); Erik Paul Alosin BERENSCHOT, Wormerveer (NL); Lisa SMITH, Aurora, CO (US)

(73) Assignee: Bunge Loders Croklaan B.V., Wormerveer (NL)

(21) Appl. No.: 17/921,835

(22) PCT Filed: Apr. 28, 2021
(86) PCT No.: PCT/EP2021/061145

§ 371 Date: Oct. 27, 2022

(30) Foreign Application Priority Data
Apr. 29, 2020 (EP) 20172216.2
Dec. 18, 2020 (GB) 2020163.8

(51) Int. Cl. A23G 1/40; A23G 1/36; A23G 1/48; A23G 1/30

(52) U.S. Cl. CPC A23G 1/40; A23G 1/36; A23G 1/48; A23G 1/305

(57) ABSTRACT

A composition for confectionery applications, which comprises: a fat composition having a solid fat content (SFC) with an N20 of at least 10% and N35 of at most 10% measured on stabilized fat stabilized at 20° C. for 40 hours according to ISO 8292-1; at least one emulsifier; and at least one bitterness inhibitor dispersed or dissolved in the fat composition.

The invention relates to a composition for confectionery applications, a confectionery product comprising such a composition and a process for preparing the composition.

### BACKGROUND

Confectionery products typically comprise a combination of fat, significant amounts of added sugar, and other ingredients such as cocoa mass. Whereas the sweet taste provided by sugar is highly appreciated by consumers, sugar has a high caloric value and is associated with several health risks. Consuming too much added sugar may raise blood pressure and increase chronic inflammation, both of which are pathways to heart disease.

In order to provide satisfactory confectionery products, a common solution is to replace sugar with low-caloric sweeteners, including several artificial and natural low-caloric sweeteners such as stevia. Whereas this approach is quite successful in liquid applications such as beverages, such low-caloric sweeteners often give rise to a less satisfactory confectionery product. In more solid products, sugar not only has the functionality of providing sweetness to a product, but also contributes to texture.

In order to balance texture issues, a solution could be to add filler materials to the product to substitute the structure functionality of sugar in combination with a low-calorie sweetener to replace the sweetness functionality. This may lead to complex systems which makes it difficult to find a satisfactory formulation. In many cases, the more sugar is reduced compared an original full-sugar recipe, the more the resulting sensory experience deviates from the indulgence by the original recipe. Also, the achieved organoleptic properties are not always stable and may diminish over time.

There remains a need for sweet tasting confectionery products with satisfactory organoleptic properties, and a relatively low sugar content. There is also a need for such confectionery products having stable organoleptic properties over time. There is also a need for methods to produce such confectionery products in a simple and convenient way.

### DESCRIPTION OF THE INVENTION

According to the present invention, a composition for confectionery applications is provided, comprising: a fat composition having a solid fat content (SFC) with an N20 of at least 10% and N35 of at most 15% measured on stabilized fat stabilized at 20° C. for 40 hours according to ISO 8292-1, at least one emulsifier, and at least one bitterness inhibitor dispersed or dissolved in the fat composition.

This composition can be used to prepare confectionery products having a relatively low (reduced) sugar content while retaining satisfactory organoleptic properties. The composition also enables a simple method to produce such confectionery products.

A composition for confectionery applications is defined as a composition that is suitable to be used to prepare a confectionery product. Confectionery products typically provide a sweet taste experience when consumed.

The term “fat” refers to glyceride fats and oils containing fatty acid acyl groups.

The term “fatty acid” refers to straight chain saturated or unsaturated (including mono- and poly unsaturated) carboxylic acids having from 8 to 24 carbon atoms. A fatty acid having x carbon atoms and y double bonds may be denoted Cx:y. For example, palmitic acid may be denoted C16:0 and oleic acid may be denoted C18:1. Percentages of fatty acids in compositions referred to herein include acyl groups in tri-, di- and mono-glycerides present in the glycerides are based on the total weight of C8 to C24 fatty acids. The fatty acid profile (i.e., composition) may be determined, for example, by fatty acid methyl ester analysis (FAME) using gas chromatography according to ISO 12966-2 and ISO 12966-4.

The fat composition in the composition according to the invention may be made from naturally occurring or synthetic fats, fractions of naturally occurring or synthetic fats, or mixtures thereof.

The term “emulsifier” refers to a substance kinetically increasing the stability of a solution, an emulsion or a dispersion, for example, lecithin, polyglycerol polyricinoleate (PGPR), sorbitan tristearate, sorbitan monostearate, mono- and diglycerides, distilled monoglycerides and propylene glycol esters of fatty acids.

Bitterness inhibitors are compounds or mixtures of compounds that in a sensory evaluation lower the bitterness tasted by a test person. Some bitterness inhibitors can be synthetically prepared, whereas others can be obtained from natural sources. The properties and methods of preparation of various bitterness inhibitors are described in patent and scientific literature, and a number of bitterness inhibitors are commercially available.

The effectiveness of a certain bitterness inhibitor may vary with the source of bitterness. Many bitterness inhibitors are developed specifically to achieve a better palatability of oral medicines comprising bitter medicinally active ingredients. In confectionery, cocoa is a known bitter ingredient, wherein the bitterness is often ascribed to cocoa alkaloids.

Examples of bitterness inhibitors and effective dosing can be found in WO2009140784 (Givaudan), WO2013072332 (Givaudan), EP3019033 (Firmenich), EP2570035 (Symrise), WO2011130705 (Kraft), and references cited therein.

The mechanism of action of bitterness inhibitors is not always clear; one of the possible mechanisms is that the bitterness inhibitor acts as an antagonist of bitter taste receptors. Examples of testing specific bitter receptors are described in for instance WO2014176336 (Chromocell), WO2008057470 (Senomyx) and references cited therein.

As stated above, the compositions of the invention comprise a fat composition having a defined solid fat content (SFC) profile. This fat composition may be present in the compositions of the present invention in an amount of at least 93% by weight based on the total weight of the composition (or at least 93.5% by weight), such at least 94% by weight (or at least 94.5% by weight), for example at least 95% by weight (or at least 95.5% by weight).

Conveniently, the fat composition may be present in an amount of at least 96% by weight (or at least 96.5% by weight), for instance at least 97% by weight (or at least 97.5% by weight). This fat composition may be included in the compositions of the present invention in an amount of at least 98% by weight (or at least 98.5% by weight) based on the total weight of the composition, such as at least 99% by weight (or at least 99.5% by weight).

Advantageously, the compositions of the present invention comprise from about 95.0 to about 99.7% by weight of this fat composition, such as from about 96.0 to about 99.5% by weight, optionally from about 96.0 to about 99.0% by weight, for example from about 96.5 to about 99.0% by weight, for instance from about 97.0 to about 99.0% by weight, optionally from about 97.0 to about 98.5% or about 98.0% by weight.

Conveniently, the compositions of the present invention comprise from about 95.7 to about 99.8% by weight (such as from about 95.960 to about 99.799% by weight) of this fat composition, such as from about 96.5 to about 99.7% by weight (such as from about 96.470 to about 99.698% by weight), for example from about 97.0 to about 99.7% by weight (such as from about 96.980 to about 99.696% by weight), optionally from about 96.985 to about 99.696% by weight, such as from about 96.990 to about 99.696% by weight.

In a preferred embodiment (the ‘first’ embodiment), the composition according to the invention has a fat composition having a solid fat content (SFC) N20 of at least 50%, an N25 of at least 40% and an N35 of at most 15%. In a more preferred embodiment, the composition according to the invention has a fat composition having a solid fat content (SFC) N20 of at least 60%, an N25 of at least 50% and an N35% of at most 12%. In a most preferred embodiment, the composition according to the invention has a fat composition having a solid fat content (SFC) N20 of from 70% to 95%, an N25 of from 52% to 70%, an N30 of from 10% to 35% and an N35 of from 0% to 10%. As explained below, such fats are suitable for use in chocolate or chocolate coatings.

These compositions according to the invention may comprise a fat composition having a solid fat content (SFC) N20 of from 50 to 90%, such as from 65 to 90%, for example from 70 to 85%.

These compositions according to the invention may comprise a fat composition having a solid fat content (SFC) N25 of from 40 to 65%, such as from 45 to 60%, for example from 50 to 60%.

These compositions according to the invention may comprise a fat composition having a solid fat content (SFC) N30 of from 5 to 35%, such as from 10 to 30%, for example from 15 to 25%.

These compositions according to the invention may comprise a fat composition having a solid fat content (SFC) N35 of from 0 to 12%, such as from 1 to 8%, for example from 1 to 5%.

Accordingly, such compositions of the invention may comprise a fat composition having a solid fat content (SFC) N20 of from 50 to 90%, an N25 of from 40 to 65%, an N30 of from 5 to 35% and an N35 of from 0 to 12%; such as a fat composition having an SFC N20 of from 65 to 90%, an N25 of from 45 to 60%, an N30 of from 10 to 30% and an N35 of from 1 to 8%; for example a fat composition having an SFC N20 of from 70 to 85%, an N25 of from 50 to 60%, an N30 of from 15 to 25% and an N35 of from 1 to 5%.

This fat composition may be present in the compositions of the present invention in an amount of at least 94 or 94.5% by weight based on the total weight of the composition of the present invention, such as at least 95 or 95.5% by weight, for example at least 96 or 96.5% by weight, optionally at least 97% by weight.

In one embodiment, the compositions of the present invention comprise from about 95.7 to about 99.8% by weight (such as from about 95.960 to about 99.799% by weight) of this fat composition, such as from about 96.5 to about 99.7% by weight (such as from about 96.470 to about 99.698% by weight), for example from about 97.0 to about 99.7% by weight (such as from about 96.980 to about 99.696% by weight), optionally from about 96.985 to about 99.696% by weight, such as from about 96.990 to about 99.696% by weight.

Conveniently, the compositions of the present invention comprise from about 96 to about 99.5% by weight of this fat composition, such as from about 96.5 to about 99.0% by weight (for example from 96.486 to 98.994% by weight), for example from about 97.0 to about 98.5% by weight (for example from 96.988 to 98.492% by weight), optionally from about 97.0 to about 98% by weight (for example from 96.990 to 97.991% by weight.).

Such fats are suitable for use in chocolate or chocolate coatings. Preferably, the fat is cocoa butter, a cocoa butter equivalent (CBE) or a cocoa butter substitute (CBS). The term “cocoa butter equivalents” refers to the combinations of other vegetable fats than cocoa butter that have physical properties and a molecular structure that are virtually identical to those of cocoa butter. The term “cocoa butter substitutes” refers to fat compositions or compounds composed mainly by lauric fats such as coconut oil, palm kernel oil etc. which have similar physical properties as cocoa butter. Cocoa butter substitutes may comprise hydrogenated fats or oils.

In another preferred embodiment (the ‘second’ embodiment), the composition according to the invention has a fat having an SFC having N20 from 30% to 70%, an N25 of from 20% to 50% and an N35 of at most 15%. In another more preferred embodiment, the composition according to the invention has a fat having an SFC having N20 from 40% to 65%, an N25 of from 25% to 45% and an N35 of at most 12%. In another most preferred embodiment, the composition according to the invention has a fat having an SFC having N20 from 45% to 60%, an N25 of from 30% to 40%, an N30 of from 5% to 20% and an N35 of from 0% to 10%. Such fats make the composition in particular suitable for a filling fat, for instance for use in filled chocolate or filled confectionery bakery applications.

These compositions according to the invention may comprise a fat composition having a solid fat content (SFC) N20 of from 35 to 70%, such as from 40 to 65%, for example from 50 to 62%.

These compositions according to the invention may comprise a fat composition having a solid fat content (SFC) N25 of from 25 to 50%, such as from 28 to 45%, for example from 30 to 40%.

These compositions according to the invention may comprise a fat composition having a solid fat content (SFC) N30 of from 0 to 30%, such as from 1 to 25%, for example from 2 to 20%.

These compositions according to the invention may comprise a fat composition having a solid fat content (SFC) N35 of from 0 to 12%, such as from 1 to 8%, for example from 1 to 5%.

Accordingly, such compositions of the invention may comprise a fat composition having a solid fat content (SFC) N20 of from 35 to 70%, an N25 of from 25 to 50%, an N30 of from 0 to 30% and an N35 of from 0 to 12%; such as a fat composition having an SFC N20 of from 40 to 65%, an N25 of from 28 to 45%, an N30 of from 1 to 25% and an N35 of from 1 to 8%; for example a fat composition having an SFC N20 of from 50 to 62%, an N25 of from 30 to 40%, an N30 of from 2 to 20% and an N35 of from 1 to 5%.

This fat composition may be present in the compositions of the present invention in an amount of at least 96 or 96.5% by weight based on the total weight of the composition of the present invention, such as at least 97 or 97.5% by weight, for example at least 98 or 98.5% by weight, optionally at least 99 or 99.5% by weight.

In one embodiment, the compositions of the present invention comprise from about 95.7 to about 99.8% by weight (such as from about 95.960 to about 99.799% by weight) of this fat composition, such as from about 96.5 to about 99.7% by weight (such as from about 96.470 to about 99.698% by weight), for example from about 97.0 to about 99.7% by weight (such as from about 96.980 to about 99.696% by weight), optionally from about 96.985 to about 99.696% by weight, such as from about 96.990 to about 99.696% by weight.

Conveniently, the compositions of the present invention comprise from about 97.5 to about 99.7% by weight of this fat composition, such as from about 98.0 to about 99.7% by weight (for example from 97.993 to 99.697%) , for example from about 98.5 to about 99.5% by weight (such as from 98.4935 to 99.4965% by weight), optionally from about 98.8 to about 99.2% by weight (for example from 98.7940 to 99.1960% by weight).

Preferably, the SFC of the compositions of the ‘first’ and ‘second’ embodiments (and accordingly the corresponding N20, N25, N30 and N35 values referenced above) is measured on stabilized fat stabilized at 20° C. for 40 hours according to ISO 8292-1.

The composition according to the invention has a fat composition that preferably comprises less than 2% by weight of trans fatty acid residues, more preferably less than 1% by weight of trans fatty acid residues. Such low trans-fat values are typically achieved in non-hydrogenated fats.

As explained above, the compositions of the present invention comprise an emulsifier. In a preferred embodiment, the emulsifier is lecithin.

The emulsifier can be present in the compositions of the invention in an amount of from 0.2 to 4% by weight based on the total weight of the composition of the present invention, such as from 0.3 to 3.0% or 3.5% by weight.

For example, the emulsifier (preferably lecithin) can be present in an amount of from 1 to 3.5% by weight, such as from 1.5 to 3% by weight, for example from 2 to 3% by weight. Alternatively, the emulsifier (preferably lecithin) can be present in an amount of from 0.3 to 2% by weight, such as from 0.5 to 1.5% by weight, for example from 0.8 to 1.2% by weight.

As explained above, the compositions of the present invention comprise a bitterness inhibitor. Conveniently, the bitterness inhibitor may be present in the compositions of the present invention in an amount of from 0.001% to 0.040% by weight based on the total weight of the composition, such as from 0.002 to 0.030% by weight, for example from 0.004 to 0.020% by weight, optionally from 0.004 to 0.015% or 0.010% by weight, for instance from 0.006 to 0.010% by weight.

For confectionery applications, it is preferred if the bitterness inhibitor is effective to antagonize the bitterness of cocoa alkaloids. In other words, it is preferred that the bitterness inhibitor inhibits the bitterness of cocoa alkaloids. Cocoa alkaloids are believed to be a main contributor to the bitterness of cocoa mass.

In a preferred embodiment, the bitterness inhibitor comprises bitterness inhibiting polysaccharides. Polysaccharides are found to have a good compatibility with confectionery applications.

Note that not every polysaccharide is a bitterness inhibitor. For instance, EP1533382 describes mixtures of Beta-glucan extracted from mycelia, mixed in oil, however the Beta-glucan as described is not known to have bitterness inhibiting properties.

It is preferred if the bitterness inhibitor comprises a plant extract, a mycelial extract, a yeast extract, an algal extract or a bacterial extract. Such bitterness inhibitors from natural origin are generally more acceptable in food applications than synthetic bitterness inhibitors.

In a preferred embodiment, the composition comprises a mycelial extract.

In a preferred embodiment, the composition according to the invention comprises from 0.001% to 0.030% by weight of mycelial extract. In a more preferred embodiment, the composition according to the invention comprises from 0.003% to 0.025% by weight of mycelial extract. In a most preferred embodiment, the composition according to the invention comprises from 0.005% to 0.015% by weight of mycelial extract.

In another preferred embodiment, the emulsifier is lecithin, and the bitterness inhibitor comprises a mycelial extract.

In a preferred embodiment, the weight ratio between the emulsifier and the bitterness inhibitor in the composition according to the invention is from 100:1 to 500:1. In a more preferred embodiment, the weight ratio between the emulsifier which is lecithin and the bitterness inhibitor which comprises mycelial extract in the composition according to the invention is from 150:1 to 300:1.

In a preferred embodiment, the compositions of the invention comprise a bitterness inhibitor which is a mycelial extract which is mostly composed of polysaccharides, mainly of alpha-glucan type, processed by fermentation of Cordyceps sinensis. For the avoidance of doubt, it is noted that this extract is different from common mushroom extracts obtained from Cordyceps sinensis per se.

In an embodiment, the composition according to the invention comprises from 0.001% to 0.030% by weight of this mycelial extract. For example, the composition according to the invention may comprise from 0.003% to 0.025% by weight of the mycelial extract, such as from 0.004% to 0.020% by weight. Preferably, the composition according to the invention comprises from 0.005% to 0.015% by weight of this mycelial extract, such as from 0.006 to 0.014% by weight, for example from 0.008 to 0.012% by weight or from 0.009 to 0.010% by weight. In another preferred embodiment, the composition of the invention may comprise from 0.003 to 0.007% by weight this mycelial extract, such as from 0.0035 to 0.0065% by weight, for example from 0.0040 to 0.0060% by weight.

Preferably, the compositions of the present invention comprise lecithin as an emulsifier and a bitterness inhibitor which is the above-disclosed mycelial extract which is mostly composed of polysaccharides, mainly of alpha-glucan type, processed by fermentation of Cordyceps sinensis.

The compositions of the present invention may comprise an emulsifier (preferably lecithin) and this mycelial extract in a weight ratio of 700:1 to 25:1, such as from 550:1 to 50:1, for example from 500:1 to 70:1, optionally from 450:1 to 100:1, for instance from 400:1 to 150:1 or from 350:1 to 200:1.

If the composition of the invention comprises a fat composition in accordance with the ‘first’ embodiment disclosed above (i.e. fats that are particularly suitable for use in chocolate or chocolate coatings), it is preferred that the composition comprises lecithin as an emulsifier in an amount of from 1 to 3.5% by weight, such as from 1.5 to 3% by weight, for example from 2 to 3% by weight. Preferably, the composition also comprises a bitterness inhibitor which is a mycelial extract which is mostly composed of polysaccharides, mainly of alpha-glucan type, processed by fermentation of Cordyceps sinensis (as disclosed above) in an amount of from 0.006 to 0.014% by weight, such as from 0.008 to 0.012% by weight, for example from 0.009 to 0.010% by weight.

It has been surprisingly found that there are considerable technical advantages associated with using these specific concentration ranges of the bitterness inhibitor in the compositions of the present invention. By way of example, for chocolate coating product applications, it has been found that when the concentration of the bitterness inhibitor is outside the broadest preferred range of from 0.006 to 0.014% by weight, the confectionery product produced displays undesirable sensory characteristics, particularly long melting time (meltdown) and high bitterness.

In one embodiment, the compositions of the present invention comprise from 1 to 3.5% by weight lecithin, from 0.006 to 0.014% by weight a mycelial extract which is mostly composed of polysaccharides, mainly of alpha-glucan type, processed by fermentation of Cordyceps sinensis and from about 96.5 to about 99.0% (for example from 96.486 to 98.994%) by weight of a fat composition in accordance with the ‘first’ embodiment disclosed above; such as from 1.5 to 3% by weight lecithin, from 0.008 to 0.012% by weight a mycelial extract which is mostly composed of polysaccharides, mainly of alpha-glucan type, processed by fermentation of Cordyceps sinensis and from about 97.0 to about 98.5% (for example from 96.988 to 98.492%) by weight of a fat composition in accordance with the ‘first’ embodiment disclosed above; for example from 2 to 3% by weight lecithin, from 0.009 to 0.010% by weight of a mycelial extract which is mostly composed of polysaccharides, mainly of alpha-glucan type, processed by fermentation of Cordyceps sinensis and from about 97.0 to about 98.0% (for example from 96.990 to 97.991%) by weight of a fat composition in accordance with the ‘first’ embodiment disclosed above.

If the composition of the invention comprises a fat composition in accordance with the ‘second’ embodiment disclosed above (i.e. fats that are particularly suitable for a filling fat, for instance for use in filled chocolate or filled confectionery bakery applications), it is preferred that the composition comprises lecithin as an emulsifier in an amount of from 0.3 to 2% by weight, such as from 0.5 to 1.5% by weight, for example from 0.8 to 1.2% by weight. Preferably, the composition also comprises a bitterness inhibitor which is a mycelial extract which is mostly composed of polysaccharides, mainly of alpha-glucan type, processed by fermentation of Cordyceps sinensis (as disclosed above) in an amount of from 0.003 to 0.007% by weight, such as from 0.0035 to 0.0065% by weight, for example from 0.0040 to 0.0060% by weight.

It has been surprisingly found that there are considerable technical advantages associated with using these specific concentration ranges of the bitterness inhibitor in the compositions of the present invention. By way of example, for chocolate filling product applications, it has been found that when the concentration of the bitterness inhibitor is higher than 0.007% by weight, the confectionery product produced displays undesirable sensory characteristics, particularly high bitterness and high hardness. Furthermore, if the concentration of the bitterness inhibitor is lower than 0.003% by weight, the sweetness of the product is significantly reduced. Accordingly, it is believed that these specific concentration ranges provide a desired balance between bitterness and sweetness intensities while maintaining a good texture (such as hardness) in a confectionery product with reduced sugar.

In one embodiment, the compositions of the present invention comprise from 0.3 to 2% by weight lecithin, from 0.003 to 0.007% by weight a mycelial extract which is mostly composed of polysaccharides, mainly of alpha-glucan type, processed by fermentation of Cordyceps sinensis and from about 98.0 to about 99.7% by weight (for example from 97.993 to 99.697%) of a fat composition in accordance with the ‘second embodiment disclosed above, such as from 0.5 to 1.5% by weight lecithin, from 0.0035 to 0.0065% by weight a mycelial extract which is mostly composed of polysaccharides, mainly of alpha-glucan type, processed by fermentation of Cordyceps sinensis and from about 98.5 to about 99.5% (for example from 98.4935 to 99.4965%) by weight of a fat composition in accordance with the ‘second’ embodiment disclosed above, for example from 0.8 to 1.2% by weight lecithin, from 0.0040 to 0.0060% by weight of a mycelial extract which is mostly composed of polysaccharides, mainly of alpha-glucan type, processed by fermentation of Cordyceps sinensis and from about 98.8 to about 99.2% (for example from 98.7940 to 99.1960%) by weight of a fat composition in accordance with the ‘second’ embodiment disclosed above.

A combination of lecithin (an emulsifier) and the above-disclosed mycelial extract which is mostly composed of polysaccharides, mainly of alpha-glucan type, processed by fermentation of Cordyceps sinensis (a bitterness inhibitor) has been surprisingly found to be particularly desirable for use in confectionery applications and especially for admixing with fat compositions to prepare confectionery products having a lower (reduced) sugar content yet displaying satisfactory or even enhanced organoleptic properties (including sweetness).

Accordingly, in another aspect of the present invention, there is provided a composition comprising or consisting of or consisting essentially of lecithin and a mycelial extract which is mostly composed of polysaccharides, mainly of alpha-glucan type, processed by fermentation of Cordyceps sinensis. For the avoidance of doubt, it is noted that this extract is different from common mushroom extracts obtained from Cordyceps sinensis per se.

The compositions of this aspect comprise, consist of or consist essentially of lecithin and the mycelial extract in a weight ratio of 700:1 to 25:1, such as from 550:1 to 50:1, for example from 500:1 to 70:1, optionally from 450:1 to 100:1, for instance from 400:1 to 150:1 or from 350:1 to 200:1. Preferably, such compositions are suitable for direct mixing with a suitably prepared (e.g. melted) fat composition to be used in a confectionery product(s) of interest, without any prior processing steps.

By consisting essentially of, we include the meaning that the relevant compositions contain substantially no other components, particularly no further components which are known in the art to act as emulsifiers or bitterness inhibitors. The term “consist of” is included within the meaning of “consist essentially of”. By “substantially no”, we include the meaning that the compositions of the invention contain 0.5% by weight or less of the stated component, preferably 0.4%, 0.3%, 0.2% or 0.1% or less, based on the total weight of the composition.

The invention further provides a confectionery product, comprising from 20% to 80% by weight of the composition according to the invention, from 10% to 50% by weight of a combination of sugar and a filler material in a weight ratio of from 1:10 to 10:1, from 10% to 70% by weight of cocoa mass, and from 0% to 10% by weight of additives.

Surprisingly, the confectionery product has satisfactory organoleptic properties, including sweetness, despite the relatively low sugar content. There is also a need for such confectionery products having stable organoleptic properties over time. There is also a need for methods to produce such confectionery products in a simple and convenient way.

Filler material is defined as a low-calorie filler material that can be added instead of the sugar. In a preferred embodiment, the confectionery product has the filler material as a percentage of the sum of filler material and sugar of at least 10%, more preferably from 10% to 60%, even more preferably from 20% to 55% by weight and most preferably from 30% to 50% by weight.

The sugar replacing filler is preferably selected from inulin, maltodextrin, aspartame, sucralose, neotame, acesulfame potassium (Ace-K), saccharin, advantame or mixtures thereof.

In a preferred embodiment, the confectionery product is a chocolate composition, a chocolate coating or a confectionery filling. Chocolate coatings or chocolate fillings can also be part of confectionery bakery products.

The invention further provides a process of preparing a composition according to the invention, comprising the steps of:
providing a fat composition; and
mixing the provided fat composition, an emulsifier and at least one bitterness inhibitor.

The ingredients can be mixed as solids (e.g. powder, granules) or liquids or both.

In a preferred embodiment, the fat composition is molten before mixing with the emulsifier (such as lecithin) and the bitterness inhibitor (such as a mycelial extract which is mostly composed of polysaccharides, mainly of alpha-glucan type, processed by fermentation of Cordyceps sinensis). This provides a convenient way to make a homogeneous mixture with good stability.

Subsequently, the composition can be processed into a confectionery product as described herein.

The listing or discussion of an apparently prior-published document in this specification should not necessarily be taken as an acknowledgement that the document is part of the state of the art or is common general knowledge.

Preferences and options for a given aspect, embodiment, feature or parameter of the invention should, unless the context indicates otherwise, be regarded as having been disclosed in combination with any and all preferences and options for all other aspects, embodiments, features and parameters of the invention.

The following non-limiting examples illustrate the invention and do not limit its scope in any way. In the examples and throughout this specification, all percentages, parts and ratios are by weight unless indicated otherwise.

### EXAMPLES

Throughout these examples:
Cx:y refers to a fatty acid having x carbon atoms and y double bonds; levels determined by GC-FAME (ISO 12966-2 and ISO 12966-4);
SAFA refers to saturated fatty acids;
MUFA refers to mono-unsaturated fatty acid;
PUFA refers to poly-unsaturated fatty acids;
IV FAME refers to calculated iodine value according to AOCS Cd 1c-85;
TRANS refers to trans fatty acids: unsaturated fatty acids having a double bond in a trans arrangement;
CNxx refers to a triglyceride having xx carbon atoms (excluding the carbon atoms from the glycerol, as is standard practice); levels determined by GC with pretreatment to remove the diglycerides eventually (AOCS Ce 5-86); and
S20Nx refers to solid fat content determined by NMR on stabilized fat (stabilized at 20° C. for 40 hours) measured at x° C. according to ISO 8292-1.

### Example 1: Fat Compositions

Two fats (CBE Fat 1 and Filling Fat 2) are prepared for the experiments in the following examples. The analytical results of these two fat compositions are shown in Table 1. Both fats are derived from fractionated non-hydrogenated and refined vegetable oil.

TABLE 1
Analytical results of CBE Fat 1 and Filling Fat 2.

| | CBE Fat 1 | Filling Fat 2 |
|---|---|---|
| C8:0 | 0.0 | 0.0 |
| C10:0 | 0.0 | 0.0 |
| C12:0 | 0.3 | 0.3 |
| C14:0 | 0.6 | 1.1 |
| C15:0 | 0.0 | 0.1 |
| C16:0 | 34.0 | 50.2 |
| C17:0 | 0.1 | 0.1 |
| C18:0 | 28.7 | 5.2 |
| C18:1 | 31.9 | 35.5 |
| C18:2 | 3.1 | 6.6 |
| C18:3 | 0.1 | 0.2 |
| C20:0 | 1.0 | 0.4 |
| C22:0 | 0.1 | 0.1 |
| C22:1 | 0.0 | 0.0 |
| C24:0 | 0.0 | 0.1 |
| SAFA | 64.8 | 57.6 |
| MUFA | 32.0 | 35.7 |
| PUFA | 3.2 | 6.7 |
| IV FAME | 28.8 | 42.5 |
| TRANS | 0.0 | 0.2 |
| CN26 | 0.0 | 0.0 |
| CN28 | 0.0 | 0.0 |
| CN30 | 0.0 | 0.0 |
| CN32 | 0.0 | 0.0 |
| CN34 | 0.0 | 0.0 |
| CN36 | 0.0 | 0.0 |
| CN38 | 0.0 | 0.0 |
| CN40 | 0.0 | 0.0 |
| CN42 | 0.0 | 0.0 |
| CN44 | 0.0 | 0.1 |
| CN46 | 0.3 | 0.3 |
| CN48 | 2.5 | 4.0 |
| CN50 | 42.4 | 58.7 |
| CN52 | 14.4 | 27.1 |
| CN54 | 38.2 | 8.3 |
| CN56 | 1.9 | 1.4 |
| CN58 | 0.2 | 0.1 |
| S20N20 | 82 | 57 |
| S20N25 | 58 | 35 |
| S20N30 | 22 | 8 |
| S20N35 | 1 | 1 |
| S20N40 | 0 | 0 |

For reference, the solid fat content (SFC) of cocoa butter determined by NMR on stabilized fat (stabilized at 20° C. for 40 hours) according to ISO 8292-1 is set out in the table below:

| SFC | Cocoa butter |
|---|---|
| S20N20 | 82 |
| S20N25 | 71 |
| S20N30 | 38 |
| S20N35 | 0 |
| S20N40 | 0 |

### Example 2: Preparation and Evaluation of Dark Super Compound, 30% Sugar Reduction

A reference dark super compound (Reference SC), a dark super compound with 30% sugar reduced (Comparative SC, 30% SR) were produced with a CBE Fat 1 as characterized in Table 1. A dark super compound with 30% sugar reduced (SC A, 30% SR) was produced with a composition according to the invention—Composition 1. Composition 1 contains 97.21% by weight of CBE Fat 1, 2.78% by weight of lecithin (Bungemaxx S1000) and 0.01% by weight of a bitterness inhibitor which was a commercially available mycelial extract containing polysaccharides. The used mycelial extract is known to inhibit cocoa alkaloids bitterness. The used mycelial extract is mostly composed of polysaccharides, mainly of alpha-glucan type, processed by fermentation of Cordyceps sinensis.

The compound coatings, were produced according to a traditional chocolate making process by mixing the dry ingredients, including Composition 1, according to Table 2 with the CBE vegetable fat to a paste, by using a Hobart mixer (Hobart, type A200) thermostated at 50° C., stirred at 50 rpm for 10 minutes. This paste was reduced in particle size (less than 25 μm) by using a roller refiner (Buhler, type 10182359). The powder from the refiner is mixed with remaining vegetable fat and lecithin by using a conch for 4 hours at 50° C. (Zum Wald, type LC-05).

TABLE 2

| Ingredients | Reference | Comparative SC, | SC A, |
|---|---|---|---|
| (wt. %) | SC | 30% SR | 30% SR |
| CBE Fat 1 | 14 | 14 | 14 |
| Cocoa liquor, Barry | 36 | 36 | 36 |
| Callebaut CM-CAL-135 | | | |
| Sugar (ultra fine | 50 | 35 | 35 |
| powder sugar, | | | |
| SuikerUnie) | | | |
| Inulin (Frutafit IQ) | 0 | 15 | 15 |
| Bitterness inhibitor | 0 | 0 | 0.002 |
| Lecithin | 0.4 | 0.4 | 0.4 |
| (Bungemaxx S1000) | | | |

After mixing, the compounds were taken out and stored at 40° C.

The 2/3 of the compounds was cooled by hand tempering on the marble table until 25° C. and mixed with the remaining warm compounds to 28-29° C. prior depositing into squares. Samples were stored at 18° C. to mature prior sensory evaluations.

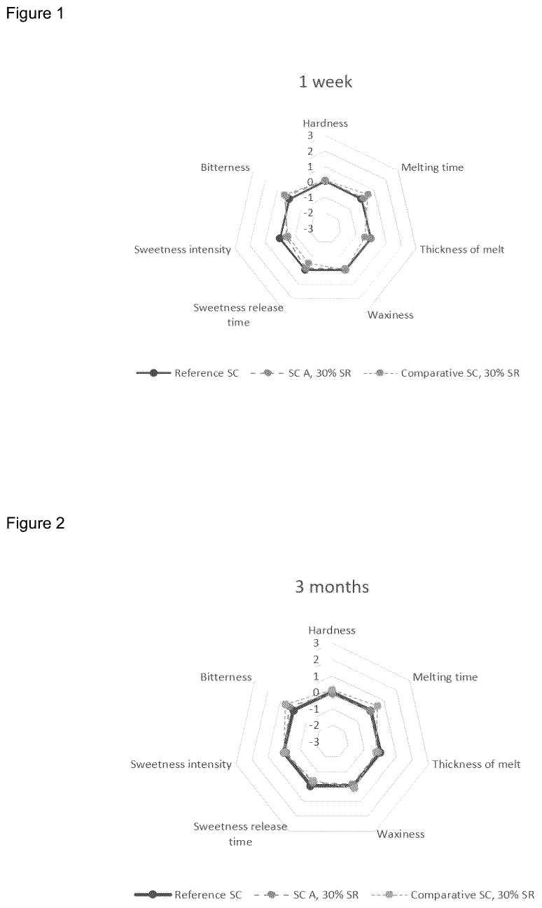

An expert sensory panel (n=5) evaluated the test samples after 1 week and repeated after 3 months of storage at 18° C. (Displayed in a spider plot diagram in FIGS. 1 and 2) The comparative SC, 30% SR and SC A, 30% SR samples were evaluated against the reference and scored them on the standard attributes in Table 3, the focus here was more on sweetness intensity, sweetness release time and bitterness.

TABLE 3

| Sensory attributes | Definition |
|---|---|
| Hardness | The force necessary to completely bite through the sample |
| | when taking it between the teeth |
| Meltdown | Total time the sample takes to completely melt in the mouth |
| Thickness of melt | The thickness of the melted sample in the mouth |
| Waxiness | Residual sample which does not melt whilst melting the |
| | sample in the mouth |
| Sweetness intensity | The intensity of the sweet taste which is released from the |
| | sample |
| Sweetness release time | The time it takes before sweetness is released in the mouth |
| Bitterness | The bitter taste which is released from the sample |

The sensory panel observed a lower sweetness release time of the Comparative SC, 30% SR compared to Reference SC and more bitterness. However, no significant difference regarding sweetness release time was observed between Reference SC and SC A, 30% SR. Less bitterness observed in the SC A, 30% SR, closer to the Reference SC.

After 3 months, more bitterness was tasted in the Comparative SC, 30% SR. While the SC A, 30% SR remained the same in bitterness. The sweetness release time after 3 months is closer to the Reference SC for the Comparative SC, 30% SR. No significant differences in both the Comparative SC, 30% SR and SC A, 30% SR regarding the sweetness intensity, similar to the Reference SC.

### Example 3: Preparation and Evaluation of Dark Super Compound, 50% Sugar Reduction

A reference dark super compound (Reference SC), a dark super compound with 50% sugar reduced (Comparative SC, 50% SR) were produced with CBE Fat 1. A dark super compound with 50% sugar reduced (SC B, 50% SR) was produced with Composition 1—the same composition according to the invention disclosed in Example 2.

The compound coatings, were produced according to a traditional Chocolate making process by mixing the dry ingredients, including Composition 1, according to Table 4 with some vegetable fat to a paste, by using a Hobart mixer (Hobart, type A200) thermostated at 50° C., stirred at 50 rpm for 10 minutes. This paste was reduced in particle size (less than 25 μm) by using a roller refiner (Buhler, type 10182359). The powder from the refiner is mixed with remaining vegetable fat and lecithin by using a conch for 4 hours at 50° C. (Zum Wald, type LC-05).

TABLE 4

| Ingredients | Reference | Comparative SC, | SC B, |
|---|---|---|---|
| (wt. %) | SC | 50% SR | 50% SR |
| CBE Fat 1 | 14 | 14 | 14 |
| Cocoa liquor, Barry | 36 | 36 | 36 |
| Callebaut CM-CAL-135 | | | |
| Sugar (ultra fine | 50 | 25 | 25 |
| powder sugar, | | | |
| SuikerUnie) | | | |
| Inulin (Frutafit IQ) | 0 | 15 | 15 |
| Maltodextrin, Maldex | 0 | 10 | 10 |
| 120 | | | |
| Bitterness inhibitor | 0 | 0 | 0.002 |
| Lecithin | 0.4 | 0.4 | 0.4 |
| (Bungemaxx S1000) | | | |

After mixing, the compounds were taken out and stored at 40° C.

The 2/3 of the compounds was cooled by hand tempering on the marble table until 25° C. and mixed with the remaining warm compounds to 28-29° C. prior depositing into squares. Samples were stored at 18° C. to mature prior sensory evaluations.

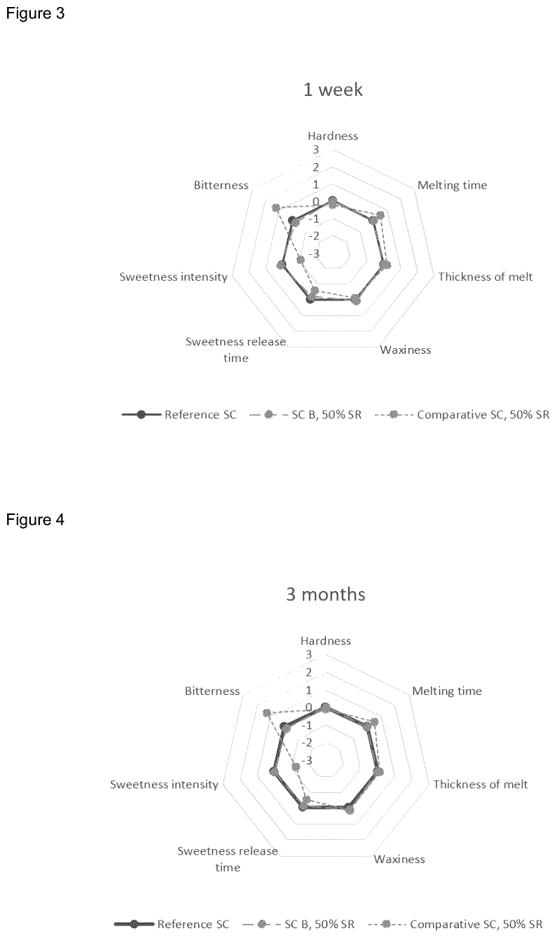

An expert sensory panel (n=5) evaluated the test samples after 1 week and repeated after 3 months of storage at 18° C. (Displayed in a spider plot diagram in FIGS. 3 and 4). The Comparative SC, 50% SR and SC B, 50% SR samples were evaluated against the Reference SC and scored them on the standard attributes in Table 3, the focus here was more on sweetness intensity, sweetness release time and bitterness.

50% sugar reduction has a significant impact on the sweetness intensity and even more on the bitterness of the Comparative SC, 50% SR. The sensory panel also observed a lower sweetness release time of the Comparative SC, 50% SR compared to Reference SC. However, no significant difference regarding sweetness release time or intensity or bitterness was observed between Reference SC and SC B, 50% SR.

After 3 months similar observations, 50% sugar reduction still has a significant impact on the sweetness intensity and bitterness in the Comparative SC, 50% SR. The sweetness release time did slightly improve but still not less than the Reference SC and SC B, 50% SR.

All attributes of sample SC B, 50% SR are similar to the Reference SC, no significant differences were observed after three months.

### Overall Conclusions From Examples 2 and 3

These examples show that the sensory profile of a dark super compound based on the Composition 1, have impact on the sweetness intensity, sweetness release time and bitterness compared to Comparative SC, 30% SR and Comparative SC, 50% SR respectively.

When a 30% sugar reduction is applied the differences are closer/comparable to the Reference SC after maturing (3 months). There is still a little bit of bitterness observed but acceptable.

When a 50% sugar reduction is applied a significant difference is observed in sweetness intensity and bitterness in the Comparative SC, 50% SR. The SC B, 50% SR scores on all attributes same as the Reference SC, no differences were observed after 1 week and after maturing (3 months).

### Example 4: Preparation and Evaluation of Chocolate Filling, 30% Sugar Reduction

A reference chocolate filling (Reference filling), a chocolate filling with 30% sugar reduced (Comparative filling, 30% SR) were produced with Filling Fat 2. A chocolate filling with 30% sugar reduced (Filling A, 30% SR) was produced with a composition according to the invention —Composition 2. Composition 2 contains 99.005% by weight of Filling Fat 2, 1.00% by weight of lecithin (Bungemaxx S1000) and 0.005% by weight of bitterness inhibitor which was a commercially available mycelial extract. The used mycelial extract is mostly composed of polysaccharides, mainly of alpha-glucan type, processed by fermentation of Cordyceps sinensis.

The ingredients according to Table 5 were mixed by using a ball mill (W-1-S, Duyvis Wiener B.V.) thermostated at 55° C., stirred at 240 rpm for 45 minutes. After mixing, the fillings were taken out, cooled until 24° C. and deposited in aluminum cups.

TABLE 5

| Ingredients | Reference | Comparative filling, | Filling A, |
|---|---|---|---|
| (wt. %) | filling | 30% SR | 30% SR |
| Filling Fat 2 | 40 | 40 | 40 |
| Sugar (caster) | 40 | 28 | 28 |
| Inulin (Frutafit IQ) | 0 | 12 | 12 |
| Skimmed milk | 10 | 10 | 10 |
| powder | | | |
| Cocoa powder | 10 | 10 | 10 |
| (alkalized) | | | |
| Bitterness inhibitor | 0 | 0 | 0.002 |
| Lecithin | 0.4 | 0.4 | 0.4 |
| (Bungemaxx S1000) | | | |

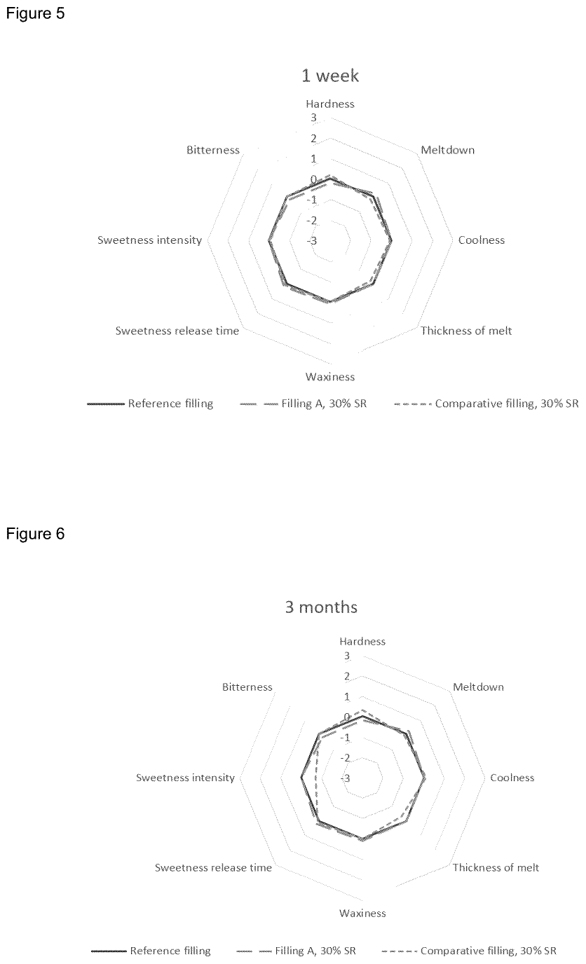

An expert sensory panel (n=5) evaluated the test samples after 1 week and repeated after 3 months of storage at 18° C. (Displayed in a spider plot diagram in FIGS. 5 and 6). The Comparative Filling, 30% SR and Filling A, 30% SR samples were evaluated against the Reference Filling and scored them on the standard attributes in Table 6, the focus here was more on sweetness intensity, sweetness release time and bitterness.

TABLE 6

| Sensory attributes | Definition |
|---|---|
| Hardness | The force necessary to completely bite through the sample |
| | when taking it between the teeth |
| Meltdown | Total time the sample takes to completely melt in the mouth |
| Coolness | The cooling or refreshing sensation in the mouth while |
| | melting the sample |
| Thickness of melt | The thickness of the melted sample in the mouth |
| Waxiness | Residual sample which does not melt whilst melting the |
| | sample in the mouth |
| Sweetness intensity | The intensity of the sweet taste which is released from the |
| | sample |
| Sweetness release time | The time it takes before sweetness is released in the mouth |
| Bitterness | The bitter taste which is released from the sample |

All attributes of Comparative Filling A, 30% SR and Filling A, 30% SR were similar to the Reference Filling. No significant differences in sweetness were noticed after 1 week.

After 3 months less sweetness intensity was observed in the Comparative Filling, 30% SR. All attributes of Filling A, 30% SR were similar to the Reference Filling, no significant differences in sweetness were noticed after 3 months.

### Example 5: Preparation and Evaluation of Chocolate Filling, 50% Sugar Reduction

A reference chocolate filling (Reference filling), a chocolate filling with 50% sugar reduced (Comparative Filling, 50% SR) were produced with Filling Fat 2. A chocolate filling with 50% sugar reduced (Filling B, 50% SR) was produced with Composition 2—the same composition according to the invention disclosed in Example 4.

The ingredients according to Table 7 were mixed by using a ball mill (W-1-S, Duyvis Wiener B. V.) thermostated at 55° C., stirred at 240 rpm for 45 minutes. After mixing, the fillings were taken out, cooled until 24° C. and deposited in aluminum cups.

TABLE 7

| Ingredients | Reference | Comparative filling, | Filling B, |
|---|---|---|---|
| (wt. %) | filling | 50% SR | 50% SR |
| Filling Fat 2 | 40 | 40 | 40 |
| Sugar (caster) | 40 | 20 | 20 |
| Inulin (Frutafit IQ) | 0 | 12 | 12 |
| Maltodextrin, Maldex | 0 | 8 | 8 |
| 120 | | | |
| Skimmed milk | 10 | 10 | 10 |
| powder | | | |
| Cocoa powder | 10 | 10 | 10 |
| (alkalized) | | | |
| Bitterness inhibitor | 0 | 0 | 0.002 |
| Lecithin | 0.4 | 0.4 | 0.4 |
| (Bungemaxx S1000) | | | |

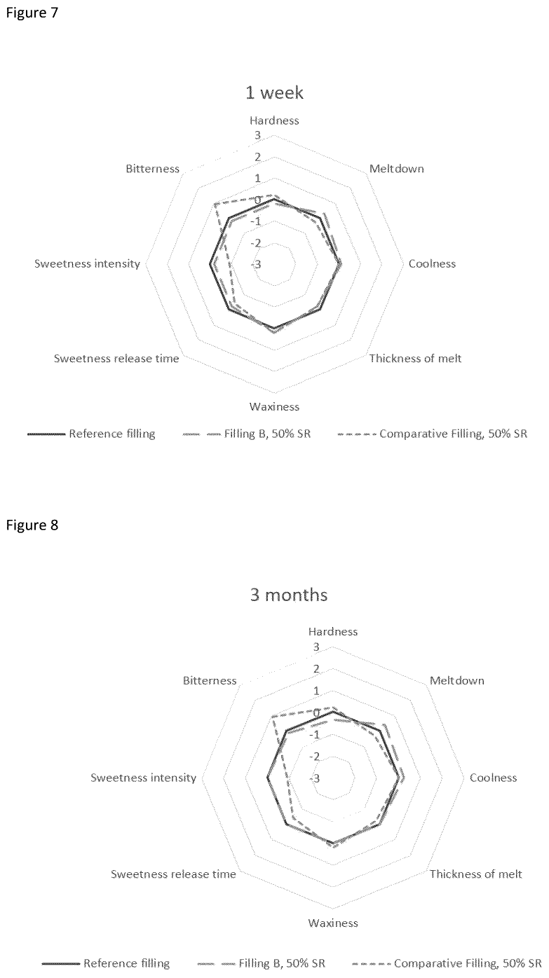

An expert sensory panel (n=5) evaluated the test samples after 1 week and repeated after 3 months of storage at 18° C. (Displayed in a spider plot diagram in FIGS. 7 and 8). The Comparative Filling, 50% SR and Filling B, 50% SR samples were evaluated against the Reference Filling and scored them on the standard attributes in Table 6, the focus here was more on sweetness intensity, sweetness release time and bitterness.

All attributes of Filling B, 50% SR were similar to the Reference Filling, no significant differences in sweetness were noticed after 1 week.

The sweetness intensity and bitterness of the Comparative Filling, 50% SR were significantly different. More bitterness was observed and the sweetness intensity was less compared to the Reference Filling and Filling B, 50% SR.

After 3 months less sweetness intensity and more bitterness were observed in the Comparative Filling, 50% SR (similar as observed after 1 week). The sweetness release time was slightly less than after 1 week.

The only attributes that shows small differences are the hardness, meltdown and coolness of Filling B, 50% SR after 3 months. The most important attributes (sweetness intensity and bitterness) do not show significant differences.

### Overall Conclusions From Examples 4 and 5

The focus was on the sweetness intensity. The sensory panel observes a lower sweetness intensity and more bitterness of Comparative Filling, 50% SR compared to Reference Filling and Filling B, 50% SR, 50% sugar reduction is applied. However, surprisingly, no significant differences regarding sweetness intensity were observed between Reference Filling and Filling A, 30% SR and Filling B, 50% SR although in Filling B, 50% SR, 50% sugar has been reduced. The 30% sugar reduction seems to have less impact on the sweetness compared the 50% sugar reduction.

### Example 6: Shelf Life at 20° C.

Chocolate fillings-overall Shelf life at 20° C.:

20° C.

| Shelf life | 3 day | 1 wk | 1 m | 3 m | 6 m |
|---|---|---|---|---|---|
| Reference Filling | 5A | 5A | 4A | 4A | 4B |
| Filling A, 30% SR | 4A | 4A | 3A | 3A | 3B |
| Filling B, 50% SR | 4A | 4A | 3A | 3A | 3B |

The sugar-reduced fillings A and B have slightly less gloss from the beginning of the shelf life compared to the reference filling, but still an acceptable value. This trend continues until 6 months, where in the last 6 months the beginning of bloom is observed in all the samples.

Super compound coatings-overall Shelf life at 20° C.:

20° C.

| Shelf life | 3 day | 1 wk | 1 m | 3 m | 6 m |
|---|---|---|---|---|---|
| Reference SC | 5A | 5A | 5A | 5A | 5A |
| SC A, 30% SR | 5A | 5A | 5A | 5A | 5A |
| SC B, 50% SR | 5A | 5A | 5A | 5A | 5A |
| SC C, 50% SR | 5A | 5A | 5A | 5A | 5A |
| SC D, 50% SR | 5A | 5A | 5A | 5A | 5A |

No significant difference observed in all the samples in the 6 months of storage.

Legend Gloss

| | |
|---|---|
| 1 | very poor, no gloss |
| 2 | poor, almost no gloss |
| 3 | average, dull gloss |
| 4 | good, good gloss |
| 5 | very good |

Legend Bloom

| | |
|---|---|
| A | no bloom - very little bloom |
| B | beginning of bloom |
| C | heavily bloomed |

1. A composition for confectionery applications, comprising:
a fat composition having a solid fat content (SFC) with an N20 of at least 10% and N35 of at most 15% measured on stabilized fat stabilized at 20° C. for 40 hours according to ISO 8292-1;
at least one emulsifier; and
at least one bitterness inhibitor dispersed or dissolved in the fat composition.

2. Composition according to claim 1, wherein the fat composition has a solid fat content (SFC) having N20 of at least 50%, an N25 of at least 40% and an N35 of at most 15%; optionally an SFC having an N20 of from 50 to 90%, an N25 of from 40 to 65%, an N30 of from 5 to 35% and an N35 of from 0 to 12%; such as an SFC with an N20 of from 65 to 90%, an N25 of from 45 to 60%, an N30 of from 10 to 30% and an N35 of from 1 to 8%; for example an SFC with an N20 of from 70 to 85%, an N25 of from 50 to 60%, an N30 of from 15 to 25% and an N35 of from 1 to 5%.

3. Composition according to claim 1, wherein the fat composition has an SFC having N20 of from 30% to 70%, an N25 of from 20 to 50% and an N35 of at most 15%, optionally an SFC having an N20 of from 35 to 70%, an N25 of from 25 to 50%, an N30 of from 0 to 30% and an N35 of from 0 to 12%: such as an SFC with an N20 of from 40 to 65%, an N25 of from 28 to 45%, an N30 of from 1 to 25% and an N35 of from 1 to 8%; for example an SFC with an N20 of from 50 to 62%, an N25 of from 30 to 40%, an N30 of from 2 to 20% and an N35 of from 1 to 5%.

4. Composition according to any of the preceding claims, wherein the emulsifier is lecithin.

5. Composition according to any of the preceding claims, wherein the bitterness inhibitor inhibits the bitterness of cocoa alkaloids.

6. Composition according to any of the preceding claims, wherein the bitterness inhibitor comprises bitterness inhibiting polysaccharides, such as polysaccharides of alpha-glucan type.

7. Composition according to any of the preceding claims, wherein the bitterness inhibitor comprises a natural flavor from a plant extract, a mycelial extract, a yeast extract, an algal extract or a bacterial extract.

8. Composition according to any of the preceding claims, wherein the bitterness inhibitor comprises a mycelial extract, such as a mycelial extract which is mostly composed of polysaccharides, mainly of alpha-glucan type, processed by fermentation of Cordyceps sinensis.

9. Composition according to any of the preceding claims, wherein the emulsifier is lecithin and wherein the bitterness inhibitor comprises a mycelial extract, such as a mycelial extract which is mostly composed of polysaccharides, mainly of alpha-glucan type, processed by fermentation of Cordyceps sinensis.

10. Composition comprising lecithin and a mycelial extract which is mostly composed of polysaccharides, mainly of alpha-glucan type, processed by fermentation of Cordyceps sinensis, preferably wherein the composition comprises or consists of or consist essentially of lecithin and the mycelial extract in a weight ratio of 700:1 to 25:1, such as from 550:1 to 50:1, for example from 500:1 to 70:1, optionally from 450:1 to 100:1, for instance from 400:1 to 150:1 or from 350:1 to 200:1.

11. A confectionery product, comprising
from 20% to 80% by weight of the composition according to any of claims 1 to 9;
from 10% to 50% by weight of a combination of sugar and a filler material in a weight ratio of from 1:10 to 10:1;
from 10% to 70% by weight of cocoa mass; and
from 0% to 10% by weight of additives.

12. Confectionery product according to claim 11, wherein the filler material as a percentage of the sum of filler material and sugar of at least 10% by weight, preferably from 10% to 60% by weight, more preferably from 20% to 50% by weight, more preferably from 25% to 40% by weight.

13. Confectionery product according to claim 11 or 12, wherein the filler material is selected from fibers, inulin, maltodextrin, sugar alcohols, erythritol, maltitol or mixtures thereof.

14. Confectionery product according to any of claims 11 to 13, wherein the confectionery composition is a chocolate composition, a chocolate coating composition or a confectionery filling composition.

15. A process for preparing a composition according to any of claims 1 to 9, comprising the steps of:
providing a fat composition; and
mixing the provided fat composition, an emulsifier (such as lecithin) and at least one bitterness inhibitor (such as a mycelial extract which is mostly composed of polysaccharides, mainly of alpha-glucan type, processed by fermentation of Cordyceps sinensis).

16. Process according to claim 15, wherein the fat is melted before mixing with the emulsifier and the bitterness inhibitor.
